(19) United States
(12) Patent Application Publication
(10) Pub. No.: US 2018/0041612 A1
(43) Pub. Date: Feb. 8, 2018

(54) SYSTEM AND METHOD FOR OUT-OF-STREAM ORDER COMPRESSION OF MULTI-MEDIA TILES IN A SYSTEM ON A CHIP

(71) Applicant: QUALCOMM INCORPORATED, San Diego, CA (US)

(72) Inventors: CHENG-CHIANG CHEN, San Jose, CA (US); HARIKRISHNA REDDY, San Jose, CA (US)

(21) Appl. No.: 15/227,476

(22) Filed: Aug. 3, 2016

(51) Int. Cl. H04L 29/06; H04L 12/863

(52) U.S. Cl. CPC H04L 69/04; H04L 69/22; H04L 47/62

(57) ABSTRACT

Various embodiments of methods and systems for out-of-stream-order compression of multi-media data tiles in a system on a chip (“SoC”) of a portable computing device (“PCD”) are disclosed. In an exemplary method an input data transaction comprising an uncompressed data tile is received. A header pixel of at least one sub-tile of the received uncompressed data tile is extracted, where the sub-tile comprises a plurality of data blocks received in an input order. The plurality of data blocks are encoded in the input order, an Idx code for each of the plurality of encoded data blocks is stored in a stream buffer. The header pixel, a BFLC code for each of the plurality of encoded data blocks, and the Idx code for each of the plurality of encoded data blocks from the stream buffer are packed into an output format.

### DESCRIPTION OF THE RELATED ART

Portable computing devices (“PCDs”) are becoming necessities for people on personal and professional levels. These devices may include cellular telephones, portable digital assistants (“PDAs”), portable game consoles, palmtop computers, and other portable electronic devices. PCDs commonly contain integrated circuits, or systems on a chip (“SoC”), that include numerous components designed to work together to deliver functionality to a user. For example, a SoC may contain any number of processing engines such as modems, central processing units (“CPUs”) made up of cores, graphical processing units (“GPUs”), etc. that read and write data and instructions to and from memory components on the SoC.

The efficient use of bus bandwidth and memory capacity in a PCD is important for optimizing the functional capabilities of processing components on the SoC. Multi-media applications on a PCD can use significant amounts of bandwidth and storage resources. For instance, the transmission and/or display of digital video or image frames require memory, buffers, channels, and buses that can support a large volume of bits. Conventionally, image data is presented in frames comprising pixels, with the higher resolution images comprising many frames and a large number of pixels.

Commonly, data compression is used to increase bandwidth availability (such as a bus bandwidth) for data being sent to a memory component through a memory controller or via direct memory access (DMA). Typical compression systems and methods can actually work to reduce efficiency in transmitting the image data and/or accessing the memory component (bytes per clock cycle). Such inefficiencies may for example be caused by the need to buffer portions of the frames comprising the image data while awaiting compression to keep the data of the frames in a required data stream order for a recipient device or component such as a decoder. Therefore, there is a need in the art for a system and method that addresses the inefficiencies associated with compressing multi-media data, and for more rapid multi-media data transactions.

### SUMMARY OF THE DISCLOSURE

Various embodiments of methods and systems for out-of-stream-order compression of multi-media data tiles in a system on a chip (“SoC”) of a portable computing device (“PCD”) are disclosed. An exemplary method begins receiving an input data transaction comprising an uncompressed data tile. A header pixel of at least one sub-tile of the received uncompressed data tile is extracted, where the sub-tile comprises a plurality of data blocks received in an input order. The plurality of data blocks are encoded in the input order, an Idx code for each of the plurality of encoded data blocks is stored in a stream buffer. The header pixel, a BFLC code for each of the plurality of encoded data blocks, and the Idx code for each of the plurality of encoded data blocks from the stream buffer are packed into an output format.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral encompass all parts having the same reference numeral in all figures.

FIG. 1 is a functional block diagram illustrating an exemplary, non-limiting aspect of a portable computing device (“PCD”) in the form of a wireless telephone for implementing methods and systems of out-of-stream-order compression of multi-media data tiles;

FIG. 2 is a functional block diagram illustrating an exemplary embodiment of an on-chip system for out-of-stream-order compression of multi-media data tiles;

FIGS. 3A-3B illustrate exemplary image tiles for which the present systems and methods may provide out-of-stream-order compression;

FIG. 4 is a functional block diagram of an embodiment of an encoder which may be implemented to provide out-of-stream-order compression of multi-media data tiles, such as the exemplary tiles of FIGS. 3A-3B;

FIGS. 5A-5B illustrate an exemplary order of compression for the image tile of FIG. 3A using the present systems and methods;

FIGS. 6A-6B illustrate an exemplary order of compression for the image tile of FIG. 3B using the present systems and methods;

FIGS. 7A-7B illustrate exemplary timing diagrams for providing out-of-stream-order compression of multi-media data tiles, such as by the encoder of FIG. 4; and

FIG. 8 is a logical flowchart illustrating a method for out-of-stream-order compression of multi-media data tiles according to an embodiment.

### DETAILED DESCRIPTION

The word “exemplary” is used herein to mean serving as an example, instance, or illustration. Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

In this description, reference to “DRAM” or “DDR” memory components will be understood to envision any of a broader class of volatile random access memory (“RAM”) and will not limit the scope of the solutions disclosed herein to a specific type or generation of RAM. That is, it will be understood that references to “DRAM” or “DDR” for various embodiments may be applicable to DDR, DDR-2, DDR-3, low power DDR (“LPDDR”) or any subsequent generation of DRAM.

As used in this description, the terms “component,” “database,” “module,” “system,” and the like are intended to refer generally to a computer-related entity, either hardware, firmware, a combination of hardware and software, software, or software in execution, unless specifically limited to a certain computer-related entity. For example, a component may be, but is not limited to being, a process running on a processor, a processor, an object, an executable, a thread of execution, a program, and/or a computer.

By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” “graphical processing unit (“GPU”),” and “chip” are used interchangeably. Moreover, a CPU, DSP, GPU or chip may be comprised of one or more distinct processing components generally referred to herein as “core(s).”

In this description, the terms “engine,” “processing engine,” “processing component” and the like are used to refer to any component within a system on a chip (“SoC”) that transfers data over a bus to or from a memory component. As such, a processing component may refer to, but is not limited to refer to, a CPU, DSP, GPU, modem, controller, etc.

In this description, the term “bus” refers to a collection of wires through which data is transmitted from a processing engine to a memory component or other device located on or off the SoC. It will be understood that a bus consists of two parts—an address bus and a data bus where the data bus transfers actual data and the address bus transfers information specifying location of the data in a memory component (i.e., metadata). The terms “width” or “bus width” or “bandwidth” refers to an amount of data, i.e. a “chunk size,” that may be transmitted per cycle through a given bus. For example, a 16-byte bus may transmit 16 bytes of data at a time, whereas 32-byte bus may transmit 32 bytes of data per cycle. Moreover, “bus speed” refers to the number of times a chunk of data may be transmitted through a given bus each second. Similarly, a “bus cycle” or “cycle” refers to transmission of one chunk of data through a given bus.

In this description, the term “portable computing device” (“PCD”) is used to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a wearable device, a combination of the aforementioned devices, a laptop computer with a wireless connection, among others.

To make efficient use of bus bandwidth and/or DRAM capacity, data is often compressed according to lossless or lossy compression algorithms, as would be understood by one of ordinary skill in the art. Because the data is compressed, it takes less space to store and uses less bandwidth to transmit. However, because DRAM typically requires a minimum amount of data to be transacted at a time (a minimum access length, i.e. “MAL”), a transaction of compressed data may require filler data to meet the minimum access length requirement. Filler data or “padding” is used to “fill” the unused capacity in a transaction that must be accounted for in order to meet a given MAL.

Multi-media applications on a PCD can use significant amounts of bandwidth and storage resources. For instance, the transmission and/or display of digital video or image frames require buses that can support a large volume of bits. Conventionally, such video and image data is presented in frames comprising pixels, with the higher resolution images comprising many frames and a large number of pixels. Frames may themselves be broken down into 256-byte data tiles comprised of pixels. Depending on the standard, the frame may be broken down into separate 256-byte data tiles for the luma/brightness (typically represented by “Y”) and chroma/color (typically represented by “UV”), and may be configured in different manners.

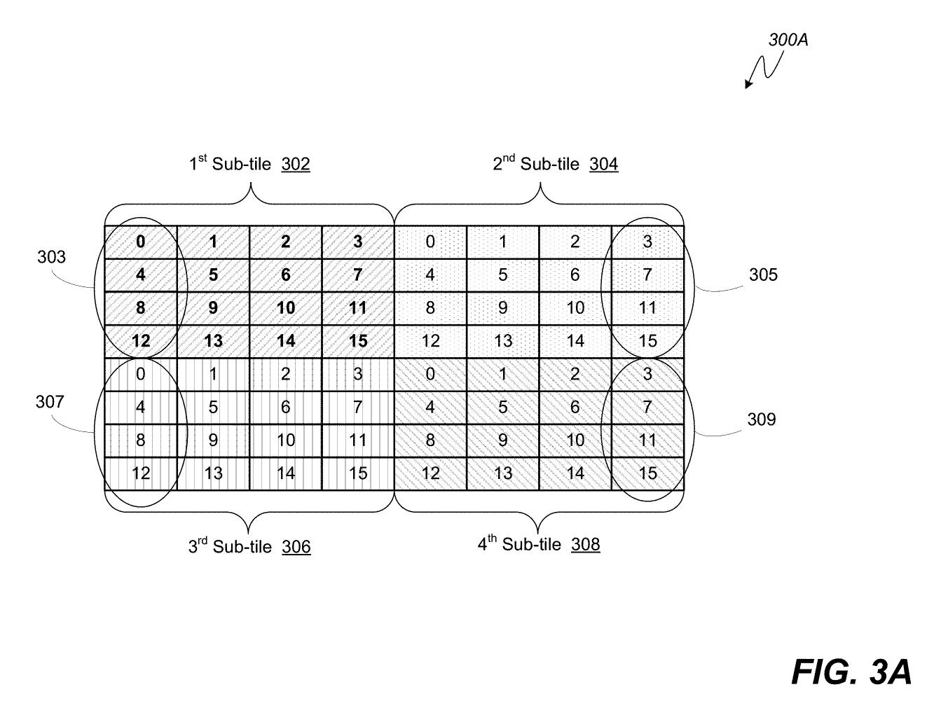

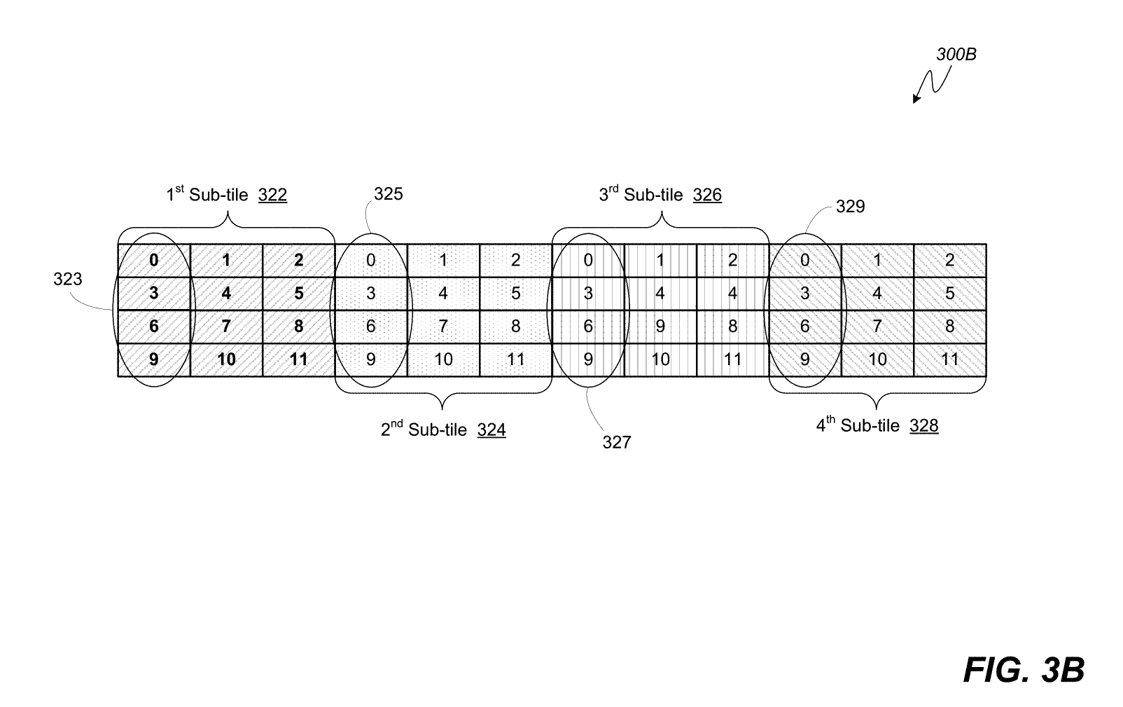

For example, FIG. 3A illustrates a 256-byte image tile 300A arranged in a 32-pixel (width)×8-pixel (height) format. Although only one image tile 300A is illustrated in FIG. 3A, it will be understood that there may be two such image tiles 300A, one for luma (Y) and one for chroma (UV). As illustrated in FIG. 3A, the image tile 300A may comprise 16-byte×4-byte sub-tiles 302, 304, 306, 308. Additionally, each sub-tile 302, 304, 306, 308 may further comprise four separate 4-pixel×4-pixel data blocks 303, 305, 307, 309, respectively. Such 4-pixel×4-pixel data blocks 303, 305, 307, 309 when grouped may be convenient sized blocks to allow transmission via a bus as a data stream. Additionally, each 4-pixel×4-pixel data block 303, 305, 307, 309 may contain 4-pixel×1-pixel portions, illustrated in FIG. 3A as 0-15 within each sub-tile 302, 304, 306, 308.

Compressing the image data contained in image tile 300A typically requires buffering the 4-pixel×4-pixel data blocks 303, 305, 307, 309 in order compress the pixels into a data stream where the pixels are arranged in the data stream in the order required by a receiving device such as a decoder (referred to herein as “in order” compression). For example, typical compression of the image tile 300A requires compressing the “0” 4-pixel×1-pixel portion of the 1^{st} sub-tile 302, then the “0” 4-pixel×1-pixel portion of the 2nd sub-tile 304, then the “0” 4-pixel×1-pixel portion of the 3rd sub-tile 306, followed by the “0” 4-pixel×1 pixel portion of the 4^{th} sub-tile 308.

The process would repeat for the “1” 4-pixel×1-pixel portions of the sub-tiles 302, 304, 306, 308, the “2” 4-pixel×1-pixel portions of the sub-tiles 302, 304, 306, 308, etc., to place the compressed pixel data of the image tile 300A into a data stream in the order needed by a recipient component such as a decoder. This compression scheme requires multiple buffers to hold the various uncompressed sub-tile 302, 304, 306, 308 pixel data while waiting for compression. Such buffers result in inefficient compression, slowing throughput, and can also take up valuable area on already over-crowded SoCs.

Other formats of multi-media tiles face the same problem. FIG. 3B, for example illustrates another 256-byte image tile 300B arranged in a 48-pixel (width)×4-pixel (height) format. Although only one image tile 300B is illustrated in FIG. 3B, it again will be understood that there may be two such image tiles 300B, one for luma (Y) and one for chroma (UV). As illustrated in FIG. 3B, the image tile 300B may comprise 12-pixel×4-pixel sub-tiles 322, 324, 326, 328. Each sub-tile 322, 324, 326, 328 may further comprise separate 4 pixel×4-pixel data blocks 323, 325, 327, 329, respectively.

Additionally, each 4-pixel×4-pixel data block 323, 325, 327, 329 may contain 4-pixel×1-pixel portions, illustrated in FIG. 3B as 0-11 within each sub-tile 322, 324, 326, 328. Compressing the image data contained in image tile 300B also typically requires buffering the 4-pixel×4-pixel data blocks 323, 325, 327, 329 “in order”—i.e. compressing the “0” 4-pixel×1-pixel portions of the sub-tile 322, 324, 326, 328, followed by the “1” 4-pixel×1-pixel portions of the sub-tiles 322, 324, 326, 328, the “2” 4-pixel×1-pixel portions of the sub-tiles 322, 324, 326, 328, etc.

The present disclosure provides cost effective and efficient systems and methods out-of-stream-order compression of multi-media data tiles, such as the image tiles 300A and 300B of FIGS. 3A-3B. The systems and methods implement an encoder configured to allow for on-the-fly compression of the portions or multi-media data tiles as those portions are received, without the need for buffers to hold the uncompressed image data/pixels before encoding/compressing. A more detailed explanation of exemplary embodiments of out-of-stream-order compression solutions will be described below with reference to the figures.

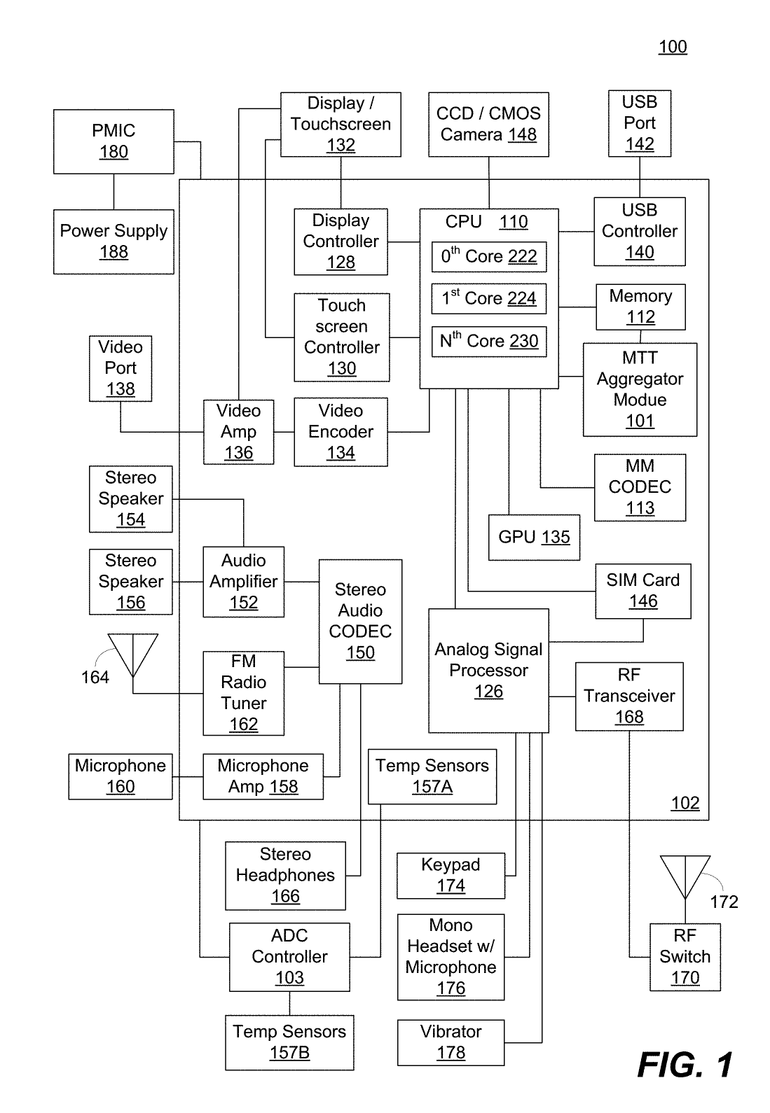

FIG. 1 is a functional block diagram illustrating an exemplary, non-limiting aspect of a portable computing device (“PCD”) 100 in the form of a wireless telephone for implementing out-of-stream-order compression of multi-media data tile methods and systems. As shown, the PCD 100 includes an on-chip system 102 that includes a multi-core central processing unit (“CPU”) 110 and an analog signal processor 126 that are coupled together. The CPU 110 may comprise a zeroth core 222, a first core 224, and an Nth core 230 as understood by one of ordinary skill in the art. Further, instead of a CPU 110, a digital signal processor (“DSP”) may also be employed as understood by one of ordinary skill in the art.

In general, multi-media (“MM”) CODEC module 113 may be formed from hardware and/or firmware and may be responsible for performing out-of-stream-order compression of multi-media data tiles. It is envisioned that multi-media data tiles, such as image tiles 300A or 300B, for instance, may be compressed out-of-stream-order according to a lossless or lossy compression algorithm executed by an image CODEC module 113 and combined into a data stream/transaction that may be processed by a receiving component such as a decompression module (not shown in FIG. 1).

As illustrated in FIG. 1, a display controller 128 and a touch screen controller 130 are coupled to the digital signal processor 110. A touch screen display 132 external to the on-chip system 102 is coupled to the display controller 128 and the touch screen controller 130. PCD 100 may further include a video encoder 134, e.g., a phase-alternating line (“PAL”) encoder, a sequential couleur avec memoire (“SECAM”) encoder, a national television system(s) committee (“NTSC”) encoder or any other type of video encoder 134. The video encoder 134 is coupled to the multi-core CPU 110. A video amplifier 136 is coupled to the video encoder 134 and the touch screen display 132. A video port 138 is coupled to the video amplifier 136. As depicted in FIG. 1, a universal serial bus (“USB”) controller 140 is coupled to the CPU 110. Also, a USB port 142 is coupled to the USB controller 140. A memory 112, which may include a PoP memory, a cache 116, a mask ROM/Boot ROM, a boot OTP memory, a type DDR of DRAM memory 115 (see subsequent Figures) may also be coupled to the CPU 110. A subscriber identity module (“SIM”) card 146 may also be coupled to the CPU 110. Further, as shown in FIG. 1, a digital camera 148 may be coupled to the CPU 110. In an exemplary aspect, the digital camera 148 is a charge-coupled device (“CCD”) camera or a complementary metal-oxide semiconductor (“CMOS”) camera.

As further illustrated in FIG. 1, a stereo audio CODEC 150 may be coupled to the analog signal processor 126. Moreover, an audio amplifier 152 may be coupled to the stereo audio CODEC 150. In an exemplary aspect, a first stereo speaker 154 and a second stereo speaker 156 are coupled to the audio amplifier 152. FIG. 1 shows that a microphone amplifier 158 may be also coupled to the stereo audio CODEC 150. Additionally, a microphone 160 may be coupled to the microphone amplifier 158. In a particular aspect, a frequency modulation (“FM”) radio tuner 162 may be coupled to the stereo audio CODEC 150. Also, an FM antenna 164 is coupled to the FM radio tuner 162. Further, stereo headphones 166 may be coupled to the stereo audio CODEC 150.

FIG. 1 further indicates that a radio frequency (“RF”) transceiver 168 may be coupled to the analog signal processor 126. An RF switch 170 may be coupled to the RF transceiver 168 and an RF antenna 172. As shown in FIG. 1, a keypad 174 may be coupled to the analog signal processor 126. Also, a mono headset with a microphone 176 may be coupled to the analog signal processor 126. Further, a vibrator device 178 may be coupled to the analog signal processor 126. FIG. 1 also shows that a power supply 188, for example a battery, is coupled to the on-chip system 102 through a power management integrated circuit (“PMIC”) 180. In a particular aspect, the power supply 188 includes a rechargeable DC battery or a DC power supply that is derived from an alternating current (“AC”) to DC transformer that is connected to an AC power source.

The CPU 110 may also be coupled to one or more internal, on-chip thermal sensors 157A as well as one or more external, off-chip thermal sensors 157B. The on-chip thermal sensors 157A may comprise one or more proportional to absolute temperature (“PTAT”) temperature sensors that are based on vertical PNP structure and are usually dedicated to complementary metal oxide semiconductor (“CMOS”) very large-scale integration (“VLSI”) circuits. The off-chip thermal sensors 157B may comprise one or more thermistors. The thermal sensors 157 may produce a voltage drop that is converted to digital signals with an analog-to-digital converter (“ADC”) controller (not shown). However, other types of thermal sensors 157 may be employed.

The touch screen display 132, the video port 138, the USB port 142, the camera 148, the first stereo speaker 154, the second stereo speaker 156, the microphone 160, the FM antenna 164, the stereo headphones 166, the RF switch 170, the RF antenna 172, the keypad 174, the mono headset 176, the vibrator 178, thermal sensors 157B, the PMIC 180 and the power supply 188 are external to the on-chip system 102. It will be understood, however, that one or more of these devices depicted as external to the on-chip system 102 in the exemplary embodiment of a PCD 100 in FIG. 1 may reside on chip 102 in other exemplary embodiments.

In a particular aspect, one or more of the method steps described herein may be implemented by executable instructions and parameters stored in the memory 112 or the multi-media CODEC module 113. Further, the multi-media CODEC module 113, the memory 112, the instructions stored therein, or a combination thereof may serve as a means for performing one or more of the method steps described herein.

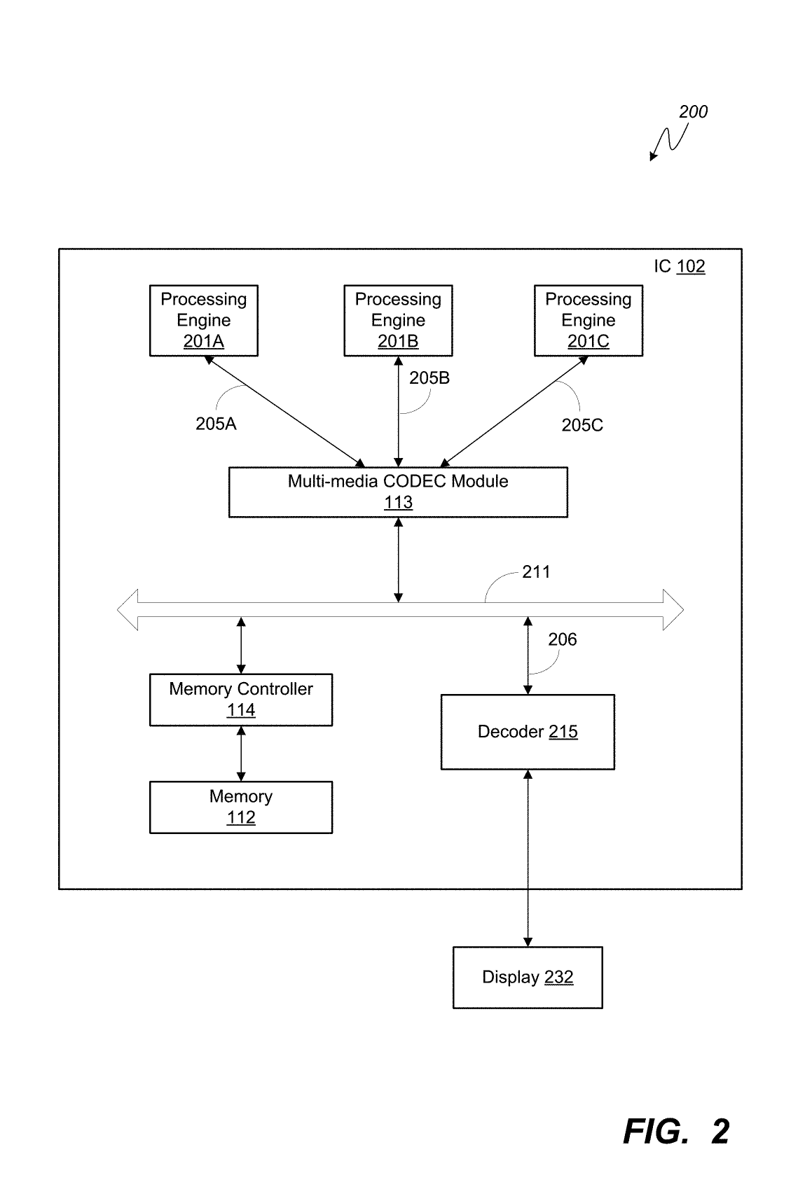

Turning to FIG. 2, a functional block diagram of an exemplary embodiment of an on-chip system 200 for out-of-stream-order compression of multi-media data tiles is illustrated. The system 200 may be implemented in an IC 102 such as SoC 102 of the PCD 100 of FIG. 1. As indicated by the arrows 205 in the FIG. 10 illustration, a processing engine 201 may be submitting transaction requests for either receiving or writing/sending multi-media data, such as image frames. For example, one or more of processing engines 201 may request to write image frames to, or read image frames from, a memory 112, via a system bus 211. The memory 112 may be a non-volatile data storage device such as a flash memory or a solid-state memory device. Although depicted as a single device, the memory 112 may be a distributed memory device with separate data stores coupled multiple processors (or processor cores).

Bus 211 may include multiple communication paths via one or more wired or wireless connections, as is known in the art and described above in the definitions. The bus 211 may have additional elements, which are omitted for simplicity, such as controllers, buffers (caches), drivers, repeaters, and receivers, to enable communications. Further, the bus 211 may include address, control, and/or data connections to enable appropriate communications among the aforementioned components.

The processing engine(s) 201 may be part of CPU 110 comprising a multiple-core processor having N core processors. As is known to one of ordinary skill in the art, each of the N cores is available for supporting a dedicated application or program. Alternatively, one or more applications or programs may be distributed for processing across two or more of the available cores. The N cores may be integrated on a single integrated circuit die, or they may be integrated or coupled on separate dies in a multiple-circuit package. Designers may couple the N cores via one or more shared caches and they may implement message or instruction passing via network topologies such as bus, ring, mesh and crossbar topologies.

As is understood by one of ordinary skill in the art, the processing engine(s) 201, in executing a workload could be fetching and/or updating instructions and/or data that are stored at the address(es) of the memory 112. Additionally, as illustrated in FIG. 2, one or more processing engine 201 may be either sending image frames directly to a display 232 for viewing by a user of the PCD 100, or may be causing image frames to be retrieved from memory 112 and forwarded to display 232. For such transactions, the image frames may be stored in memory 112 and/or transmitted to display 232 in a compressed form as compressed image data. Such compressed image data may be decompressed, such as by decoder 215 before the image frames are received by the display 232.

As the processing engines 201 generate data transfers for transmission via bus 211 to memory 112 and/or display 232 multi-media CODEC module 113 may compress tile-sized units of an image frame to make more efficient use of DRAM 115 capacity and/or bus 211 bandwidth. As discussed below, the multi-media CODC module 113 may be configured to perform out-of-stream compression of the data tiles for the image frame. The out-of-stream compression of the data tiles may be stored in memory 112 and/or provided to decoder 215 in a data stream that the decoder 215 may act on to decompress the data tiles for viewing on the display 232. In this description, the various embodiments are described within the context of an image frame made up of 256-byte tiles.

Notably, however, it will be understood that the 256-byte tile sizes, as well as the various compressed data transaction sizes, are exemplary in nature and do not suggest that embodiments of the solution are limited in application to 256-byte tile sizes. As such, one of ordinary skill in the art will recognize that the particular data transfer sizes, chunk sizes, bus widths, etc. that are referred to in this description are offered for exemplary purposes only and do not limit the scope of the envisioned solutions as being applicable to applications having the same data transfer sizes, chunk sizes, bus widths, etc. As will become more apparent from further description and figures, out-of-stream order compression, may improve the effectiveness and transaction throughput of the multi-media encoder module 113, while at the same time reducing the footprint on the SoC required for the encoder module 113 resulting in cost and manufacturing savings.

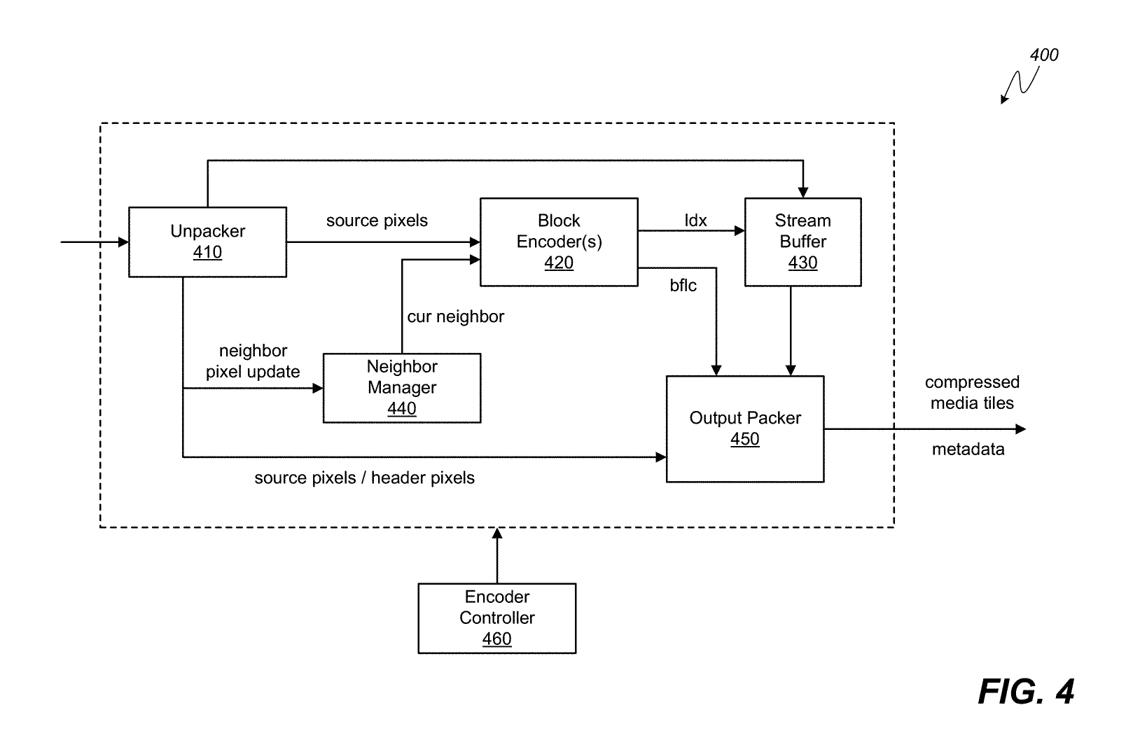

Turning to FIG. 4, a functional block diagram of an embodiment of an encoder 400 is illustrated. The encoder 400 may be, or may be a part of, the multi-media CODEC module 113 illustrated in FIGS. 1 and 2. The encoder 400 may provide out-of-stream-order compression of multi-media data tiles, such as the exemplary image tiles 300A and 300B of FIGS. 3A-3B. In an embodiment, the encoder 400 comprises Unpacker 410 that receives an input data stream, such as from processing engines 201 of FIG. 2. The input data stream comprises uncompressed multi-media tiles, such as image tiles 300A (FIG. 3A) or 300B (FIG. 3B), which may be formatted in 128-bit (for 8-bit per pixel mode) or 160-bit (for 10-bit per pixel mode) per input transaction received by the Unpacker 410.

The input transaction of multi-media tiles received by the Unpacker 410 comprises uncompressed pixel data (“source pixels”). The received input transaction may be arranged as 4-pixel×4-pixel data blocks 303, 305, 307, 309 (see FIG. 3A), or as 4-pixel×4-pixel data block 323, 325, 327, 329 (see FIG. 3B), or in other sized block units as desired. As will be understood, the block units for a particular multi-media tile may not be received in an order that corresponds to the order of block units required by a downstream decoder to process/decompress the tile data to display the multi-media frame.

After receiving the input transaction, the Unpacker 410 extracts header pixels for the sub-tiles of a received tile in the input transaction, such as header pixels for sub-tiles 302, 304, 306, 308 of FIG. 3A or sub-tiles 322, 324, 326, 328 of FIG. 3B. The Unpacker 410 forwards the header pixels for each sub-tile to the Output Packer 450. The Unpacker 410 also extracts all of the source pixels for each received unit block of the received tile in the input transaction. Unpacker 410 forwards the source pixels to both the Output Packer 450 and to the Block Encoder 420.

Unpacker 410 forwards the source pixels of each received block unit to the Block Encoder 420 for compression in the order the block units are received by the Unpacker 410 in the input data stream. In other words, the encoder 400 of FIG. 4 and/or Unpacker 400 does not use input buffers or otherwise re-arrange the received block units into a data stream order required by a downstream component (such as a decoder) before compressing the source pixels.

Finally, Unpacker 410 provides a neighbor pixel update to Neighbor Manager 440. The neighbor pixel update comprises information about one or more pixels adjacent to or adjoining the pixel being compressed by the Block Encoder 410. In an embodiment, the Neighbor Manager 440 receives from Unpacker 410 and stores information about the neighbor pixels to the pixels being sent to the Block Encoder 420 for compression. Such information may include values for the neighbor pixel(s) as well as header pixels for sub-tile neighbors, etc.

Neighbor Manager 440 then provides this neighbor information for each pixel as the pixel is being compressed by the Block Encoder 410, enabling better compression performance and/or predictability. Neighbor Manager 440 is continually receiving neighbor pixel information updates from the Unpacker 410 corresponding to source pixels the Unpacker 410 is forwarding to the Block Encoder 420. Neighbor Manager 440 stores such neighbor pixel information until needed by the Block Encoder 420 and forwards the neighbor pixel information to the Block Encoder 420.

In an embodiment, Neighbor Manager 440 provides values or information about the left, top-left, and top neighbors to the pixel currently being encoded by Block Encoder 420. Neighbor Manager 440 may in some embodiments simultaneously provide neighbor pixel information for multiple pixels being compressed by the Block Encoder 420, such as for example, neighbor pixels for a 4-byte×4-byte data block 303, 305, 307, 309 (see FIG. 3A).

Block Encoder 420 receives the source pixels from the Unpacker 410 and the neighbor pixels from Neighbor Manager 440 and encodes/compresses the pixels of the received block unit using any desired algorithm. As discussed above, Block Encoder 420 encodes the block unit pixels in the order that the block units are received by the Unpacker 410, rather than in an order required by a downstream component such as a decoder.

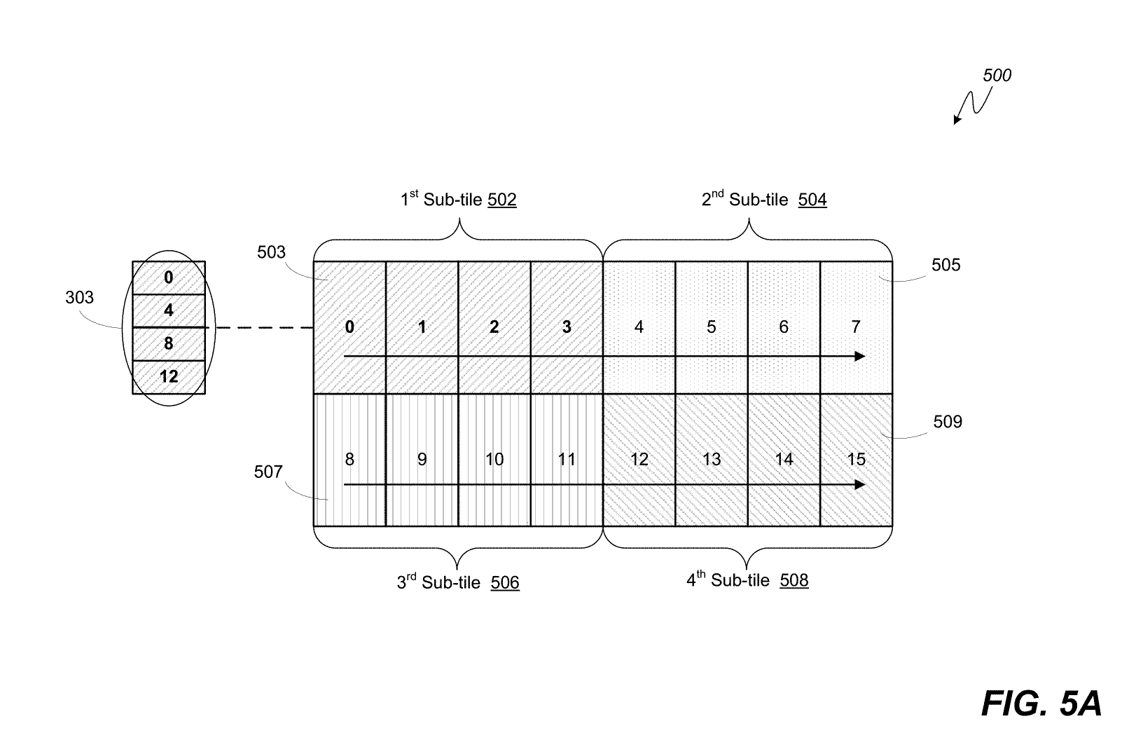

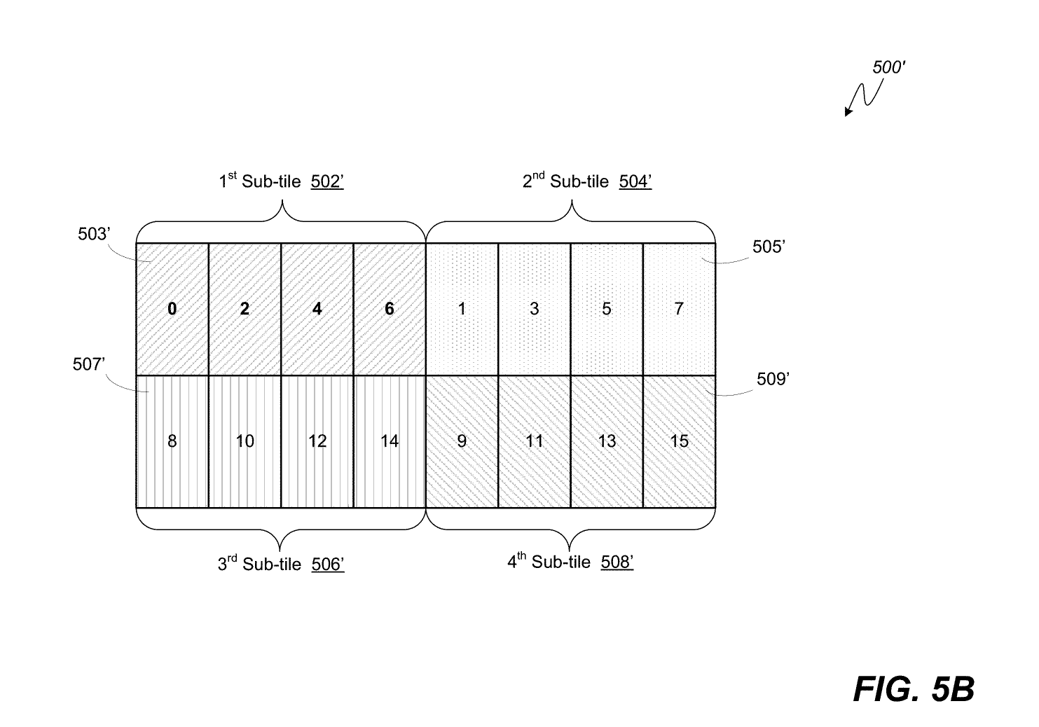

For example, FIGS. 5A and 5B illustrate an order of compression of image frames 500 and 500′ respectively based on the order in which the frame data is received, such as by the Unpacker 410 of FIG. 4. Image frames 500 and 500′ are in the 32-pixel×8-pixel format, similar to image frame 300A of FIG. 3A, with image frame 500 comprising the luma/Y frame and image frame 500′ representing the chroma/UV frame. As illustrated in FIG. 5A, the portions of the sub-tiles 502, 504, 506, 508 are received as 4-pixel×4-pixel blocks 503 (labeled 0-3), 505 (labeled 4-7), 507 (labeled 8-11), and 509 (labeled 12-15), respectively. As also shown in FIG. 5A, the first block 503 (labeled 0) corresponds to one of the data blocks 303 of FIG. 3A, and in particular corresponds to portions 0, 4, 8, and 12 of data block 303.

The present system and method do not buffer the data blocks 503, 505, 507, 509 in order to compress the portions of each sub-tile 502, 504, 506, 508 in output data stream order as discussed above for FIG. 3A (i.e. first compress all of the “0” portions, then the “1” portions). Instead, the blocks 0-15 of FIG. 5A-5B are compressed in the order received in the input data stream, beginning at block 0 (corresponding to portions 0, 4, 8, 12 of data block 303 of FIG. 3A) to block 15. Accordingly, in FIG. 5A blocks 0 to 7 are first compressed in the order received/numeric order (illustrated by the arrow), and then blocks 8 to 15 are compressed in the order received/numeric order (illustrated by the arrow). Similarly, in FIG. 5B, blocks 0 to 7 are first compressed in the order received/numeric order, resulting in an interleaving of blocks from the first sub-tile 502′ and second sub-tile 504′. Then blocks 8 to 15 are compressed in the order received/numeric order, resulting in an interleaving of blocks from the third sub-tile 506′ and fourth sub-tile 508′. As will be understood, if the blocks 0-15 are received in an order other than illustrated in FIG. 5A or 5B, the order of compression will correspondingly be different than illustrated.

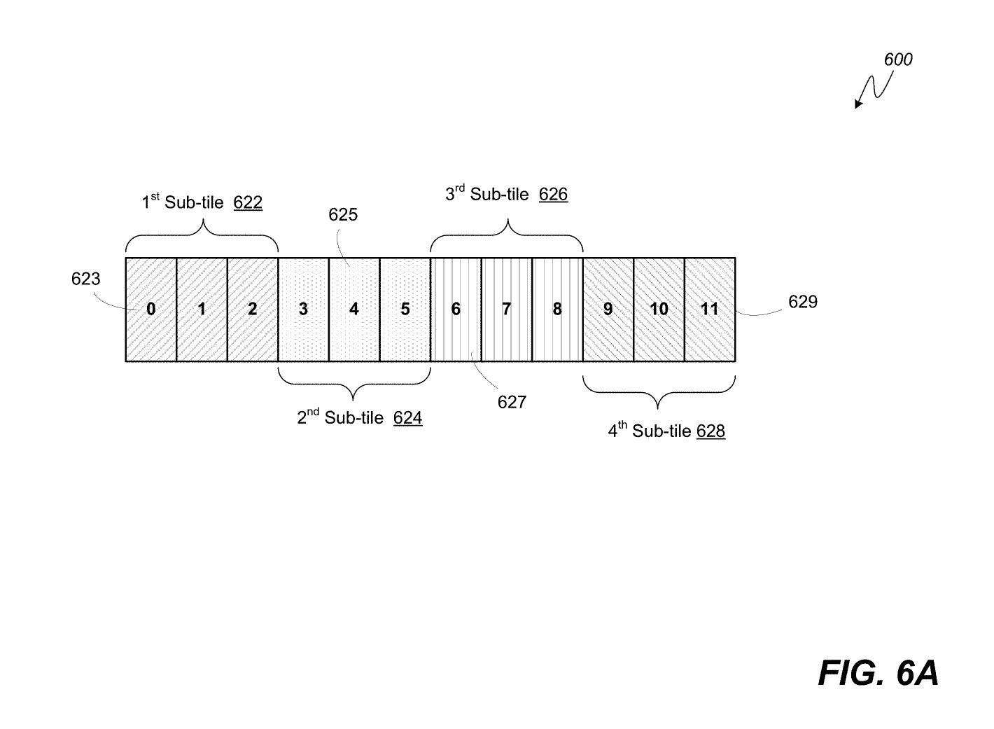

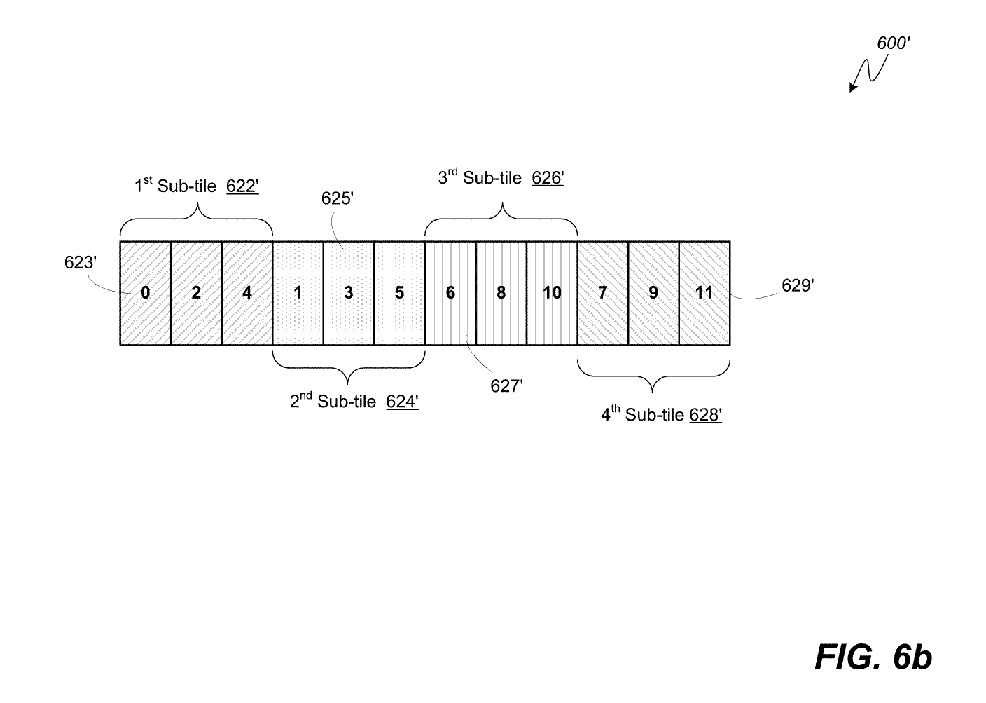

By way of another example, FIGS. 6A and 6B illustrate an order of compression of image frames 600 and 600′ respectively based on the order in which the frame data is received, such as by the Unpacker 410 of FIG. 4. Image frames 600 and 600′ are in the 48-pixel×4-pixel format, similar to image frame 300B of FIG. 3B, with image frame 600 comprising the luma/Y frame and image frame 600′ representing the chroma/UV frame. As illustrated in FIG. 6A, the portions of the sub-tiles 602, 604, 606, 608 of the luma/Y frame are received as 4-byte×4-byte blocks 623 (labeled 0-2), 625 (labeled 3-5), 627 (labeled 6-8), and 629 (labeled 9-11), respectively. As with FIG. 5A above, blocks 0-11 of FIG. 6A for the luma/Y frame are compressed in the order received in the input data stream, beginning at block 0 to block 11. Accordingly, in FIG. 6A blocks 0-2 are first compressed in the order received/numeric order, followed by blocks 3-5, blocks 6-8, and 9-11.

However, as illustrated in FIG. 6B, a different order is followed for the chroma/UV frame. Block 0 from the first sub-tile 622′ is compressed, followed by block 1 of the second sub-tile 624′, followed by block 2 of the first sub-tile 622′, etc., interleaving the blocks of the first sub-tile 622′ and second sub-tile 624′. Then, the blocks of the third sub-tile 626′ and fourth sub-tile 628′ are similarly interleaved beginning with block 6 of the third sub-tile 626′, followed by block 7 of the fourth sub-tile 638′, etc. As will be understood, if the blocks 0-11 are received in an order other than illustrated in FIG. 6A or 6B, the order of compression may correspondingly be different than illustrated.

Returning to FIG. 4, in an embodiment, Block Encoder 420 may encode and/or compress each pixel by first performing a prediction for the pixel to determine an Idx value or code representing the prediction error for the compressed pixels. The pixel may then be encoded using a desired algorithm based on the Idx value or code. In an embodiment, the encoding may be performed using a block fixed length coding (BFLC) technique to generate BFLC codes for the compressed pixels. Block Encoder 420 may comprise multiple encoding engines/processes operating in parallel, with each encoding engine/process able to process a certain number of pixels per clock cycle. Alternatively, or additionally, in some embodiments the encoder 400 may comprise multiple Block Encoders 420 operating in parallel (not illustrated).

For example, in an embodiment, each encoding engine/process may be able to process a 4×4-pixel block per clock cycle such as data blocks 303, 305, 307, 309 of FIG. 3A. In one implementation of this embodiment, Block Encoder 420 may comprise two sub-encoding engines operating in parallel to allow encoding of two 4×1-pixel blocks (4×2 pixels) per clock cycle. In a second implementation, Block Encoder 420 may comprise four sub-encoding engines to allow encoding of four 4×1-pixel blocks (4×4 pixels) per clock cycle.

In another embodiment, each encoding engine/process may be able to process a 4×4-pixel block per clock cycle such as data blocks 323, 325, 327, 329 of FIG. 3B. In one implementation of this embodiment, Block Encoder 420 may comprise two sub-encoding engines operating in parallel to allow encoding of two 4×1-pixel blocks (4×2 pixels) per clock cycle. In a second implementation, Block Encoder 420 may comprise four sub-encoding engines to allow encoding of four 4×1-pixel blocks (4×4 pixels) per clock cycle. The second implementation in each embodiment allows for faster compression/encoding throughput, at the cost of increased chip area, power consumption, heat, etc. required for the additional encoding engines/processes. The number of sub-encoding engines implemented can differ, and may depend on various factors such as PCD and/or SoC architecture, the use to which the PCD will be put, the encoding algorithms used, etc.

Block Encoder 420 may also make a determination whether a 256-byte tile will be output from the encoder 400 as compressed blocks or whether the uncompressed source pixels of the 256-byte tile will be output from the encoder 400. Such uncompressed source pixels output from the encoder 400 are referred to herein as a “PCM tile.” This determination may be made by the Block Encoder 420 based on the size of the data tile after compression.

In an embodiment, the data tile may be encoded/compressed by the Block Encoder 420 into a compressed tile having a size that is multiples of 32 bytes (i.e. 32 bytes, 64 bytes, 96 bytes, etc.) in case the compressed blocks are sent to an external memory. In such embodiments, if the compressed tile is 224 bytes or greater, the compressed tile is discarded, and the uncompressed data tile will be output from the encoder 400 as a PCM tile.

After encoding the received block units, Block Encoder 420 outputs the Idx codes to a Stream Buffer 430 and the BFLC codes to the Output Packer 450. Note that in cases where the Block Encoder 420 determines that the certain 4×1 source pixels should be output uncompressed, the corresponding BFLC code may indicate that certain 4×1 pixel block is a PCM block.

Stream Buffer 430 stores the 4-pixel compressed (or PCM) blocks from the Block Encoder 420, adding compressed (or PCM) blocks for a multi-media tile as they are received from the Block Encoder 420, until the Output Packer 450 is ready to send an output transaction as described below. Stream Buffer 430 stores the compressed blocks, and provides the compressed blocks to Output Packer 450, in output stream order—i.e. an order needed by a downstream component such as a decoder to decompress the multi-media tile. Stream Buffer 430 may be implemented with a flop array or RAM memory as desired in a variety of configurations.

For example, Stream Buffer 430 may comprise a 128-bit×16 bit flop array structure to store an entire multi-media tile, addressed in block linear order for each sub-tile. In another embodiment, where four sub-encoding engines of Block Encoders 420 are implemented, the Stream Buffer 420 may comprise four 40 (width)×16 (height) dual port Ram memories that are word writable. Block addresses in such an implementation may be mapped in a way to support a 4-block write/read per clock cycle. As would be understood, this implementation allows for more throughput, but requires a larger total chip area for the RAM memory. In yet another embodiment, where only two sub-encoding engines of Block Encoders 420 are implemented, Stream Buffer 420 may comprise two 40 (width)×32 (height) dual port RAM memories that are word writable. This implementation provides less throughput, but also requires a smaller total chip area for the RAM memory.

The encoder 400 of FIG. 4 also includes an Output Packer 450 for packing the compressed (or PCM) blocks into an output interface format, which may be 128-bit per output transaction. Output Packer 450 receives for each block, the header pixels from the Unpacker 410, the BFLC codes from the Block Encoder 420, and the Idx values in stream order from the Stream Buffer 430. For compressed blocks, Output Packer 450 inserts the header pixel field, BFLC field, and any padding needed in the padding field for the compressed tile, resulting in an output transaction. Additionally, the Output Packer 450 sends metadata for each tile, where the metadata is configured to inform downstream components or modules how big the compressed media tile is. For example, in an embodiment, if the media tile is compressed to 32 bytes the metadata may have a value of 1, if the media tile is compressed to 64 bytes, the metadata may have a value of 3, etc.

Note that where the BFLC codes and/or Idx values received at the Output Packer 450 indicate that the output will be a PCM (uncompressed) tile, the Output Packer 450 will convert the PCM tile to an appropriate format for transmission in an Output transaction. In an embodiment, when the Output Packer 450 receives such indication that the output will be a PCM tile the Output Packer 450 may perform such conversion on the source pixels received from the Unpacker 410 as mentioned above. In some implementations, the Output Packer 450 may send a signal to the Unpacker 410 to re-send the source pixels prior to performing such conversion.

Encoder 400 also includes an Encoder Controller 460 that controls the flow of information between the other portions of encoder 400 as described above. As will be understood, Unpacker 410, Block Encoder 420, neighbor Manager 440, Output Packer 450, and Encoder Controller 460 may be implemented in hardware, software, or both in various embodiments. Additionally, encoder 400 may include more or fewer components or modules than those illustrated in FIG. 4, and such components or modules may be configured or arranged differently than illustrated in FIG. 4.

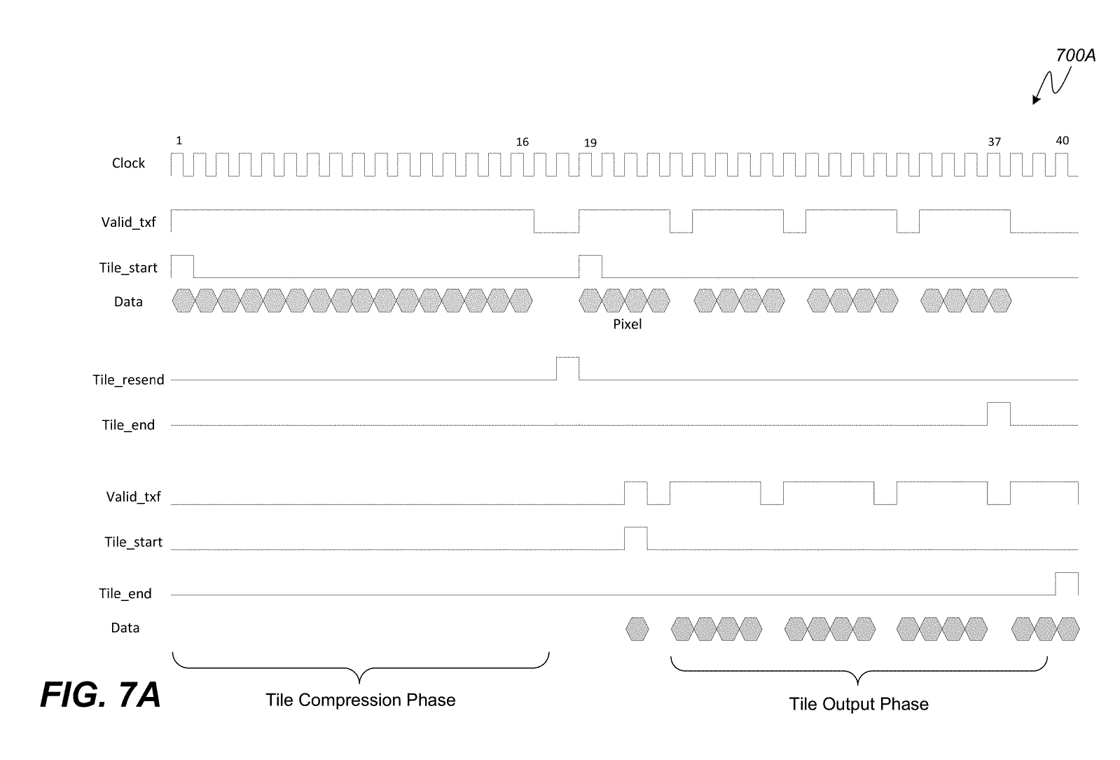

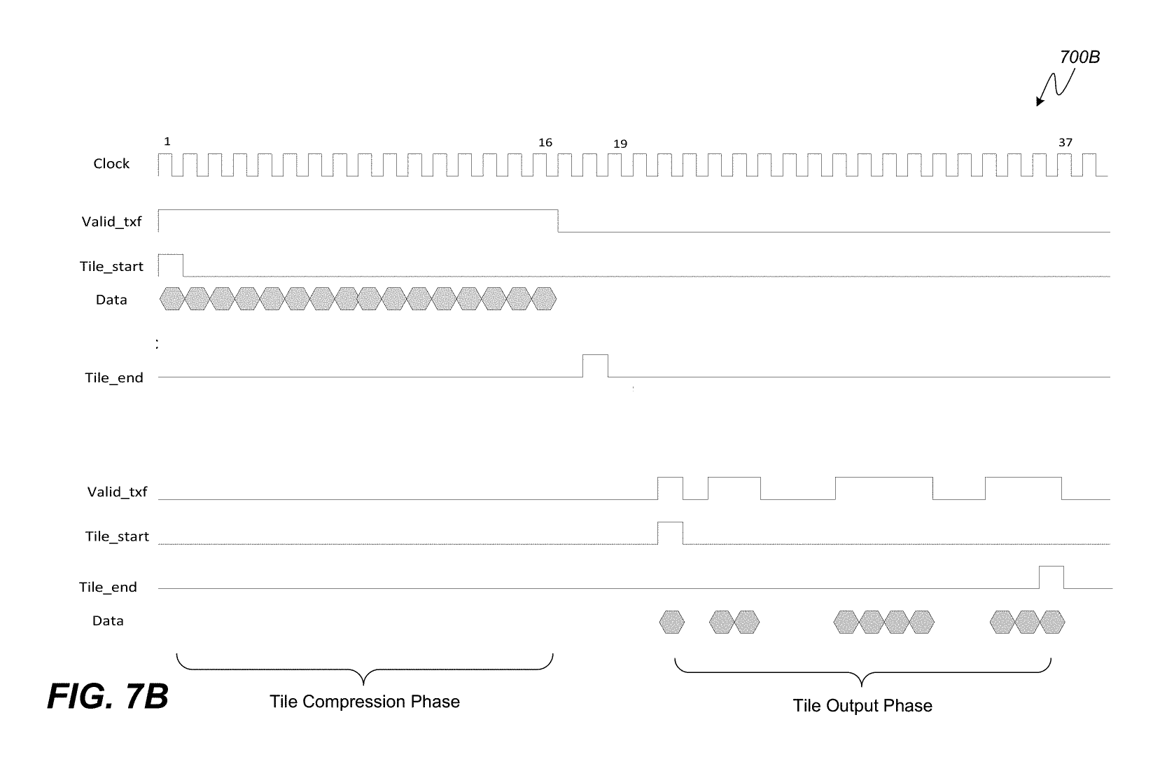

Turning to FIGS. 7A-7B, exemplary timing diagrams 700A and 700B for an embodiment of the present system and method is illustrated. Timing diagram 700A illustrates timing for a “worst case” where an encoder such as encoder 400 described above attempts to encode a tile such as image tile 300B of FIG. 3B. In the example timing diagram 700A of FIG. 7A, the output tile is a PCM tile and a PCM tile resend is sent. As illustrated in FIG. 7A the throughput per image tile 300B in this example is only 40 clock cycles, resulting in significant throughput improvement over previous compression systems and methods. Timing diagram 700B illustrates an encoder such as encoder 400 described above encoding a tile such as image tile 300B of FIG. 3B, the encoder 400 configured with a 16-pixel block per clock cycle. In the example timing diagram 700B of FIG. 7B, the image tile 300B is compressed as discussed above, with a throughput per image tile 300B of 37 clock cycles, again a significant throughput improvement over previous compression systems and methods.

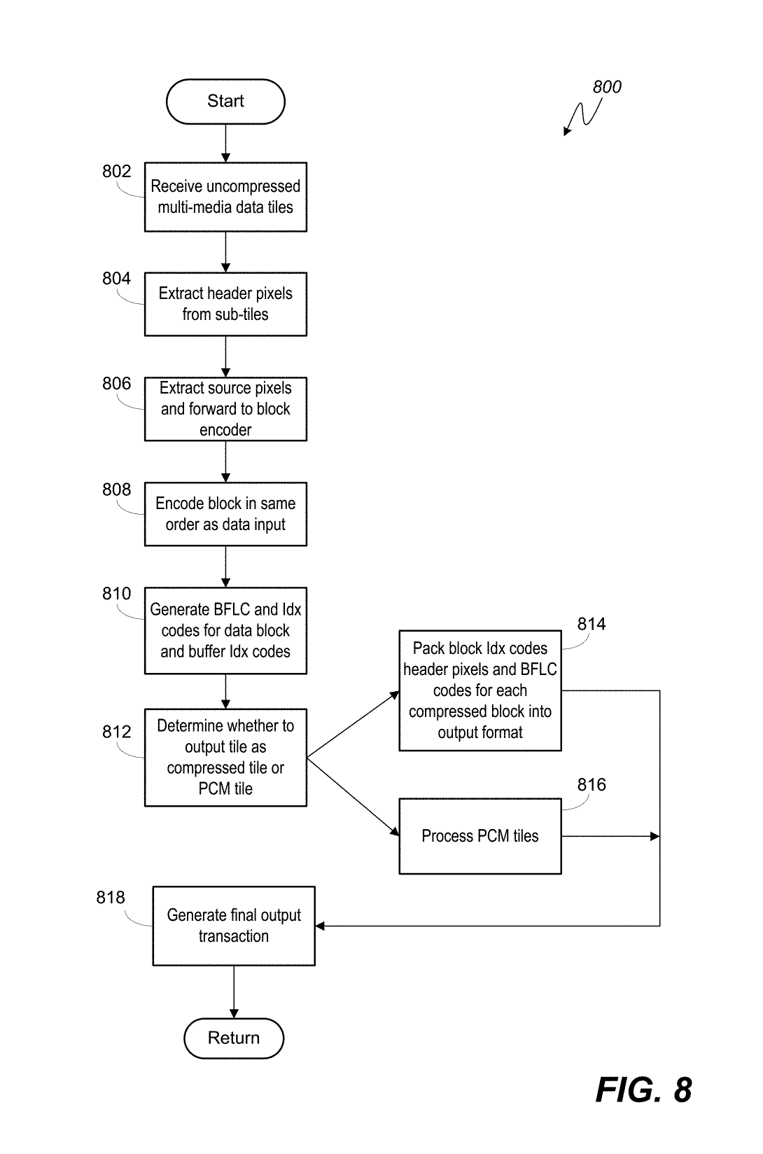

FIG. 8 is a logical flowchart illustrating an exemplary method 800 for out-of-stream-order compression of multi-media data tiles, such as the exemplary image tiles 300A and 300B of FIGS. 3A-3B. Method 800 may be performed in an embodiment by a multi-media CODEC module 113 of FIG. 2, including a module 113 with the encoder 400 illustrated in FIG. 4. Beginning at block 802, uncompressed multi-media data tiles are received. As will be understood, such tiles may be portions of video or image frame comprising pixels (“source pixels”), including exemplary image tiles 300A and 300B of FIGS. 3A-3B, forwarded from an upstream component or module such as a processing engine. In an embodiment, the uncompressed multi-media data tiles may be received as part of an input data stream or transaction and may comprise data blocks of a sub-tile of the multi-media data tiles. As discussed above, for FIG. 4, the input data stream may be in a 128-bit (for 8-bit per pixel mode) or 160-bit (for 10-bit per pixel mode) format per input transaction and may be received by an encoder 400, such as by an Unpacker 410.

At block 804, header pixels are extracted from the sub-tiles of a received tile in the input transaction, such as header pixels for sub-tiles 302, 304, 306, 308 of FIG. 3A or sub-tiles 322, 324, 326, 328 of FIG. 3B. In an embodiment the header pixels may be forwarded to another component or module of the encoder 400, such as Output Packer 450 illustrated in FIG. 4. At block 806, the source pixels for each data block are extracted and forwarded to a block encoder, such as Block Encoder 420 of FIG. 4.

Method 800 continues to block 808 where each block of source pixels is encoded/compressed in the same order as the data input stream/transaction of block 802. The encoding/compression may be performed by one or more Block Encoder(s) 420, and in some embodiments each Block Encoder 420 may comprise multiple sub-encoding/compressing engines operating in parallel. In an embodiment, the Unpacker 410 forwards the source pixels of each received block unit to the Block Encoder 420 for compression in the order the block units are received by the Unpacker 410 in the input data stream/transaction. In other words, the Unpacker 400 does not use input buffers or otherwise re-arrange the received block units into a data stream order required by a downstream component (such as a decoder) before sending the source pixels to the Block Encoder 420 for encoding/compression.

In some embodiments, the encoding in block 808 may also be performed using neighbor pixel information related to a pixel being compressed in order to better and/or more efficiently compress or encode the pixel. As discussed above, Block Encoder 420 may receive such neighbor pixel information from a Neighbor Manager 440 of encoder 400, where the Neighbor Manager 400 receives neighbor pixel updates from Unpacker 410 as illustrated in FIG. 4.

In block 810 BFLC and Idx codes or values are generated by the Block Encoder 420 for each data block as part of the encoding/compressing of the data block. Each block's Idx codes or values are buffered in block 810, such as in Stream Buffer 430. Stream Buffer 430 may store 4-pixel compressed blocks from the Block Encoder 420 in an embodiment, adding compressed blocks for a multi-media tile as they are received from the Block Encoder 420, until the Output Packer 450 is ready to send an output transaction as described above. Stream Buffer 430 may store the compressed blocks, and provide the compressed blocks to Output Packer 450, in output stream order—i.e. an order needed by a downstream component or module such as a decoder to decompress the multi-media tile.

In block 812, the Block Encoder 420 may determine whether a multi-media tile will be output from the encoder 400 as compressed tile or whether the uncompressed source pixels (arranged in PCM tile format) will be output from the encoder 400. In an embodiment, this determination may be made by the Block Encoder 420 based on the size of the data tile after compression. Depending on the determination at block 812, method 800 continues to either block 814 (output compressed tile) or block 816 (output PCM tile).

In the event that the determination at block 812 is to output compressed blocks, method 800 continues to block 814 where the compressed blocks are packed into the output format. In an embodiment, Output Packer 450 receives for each block, the header pixels from the Unpacker 410, the BFLC codes from the Block Encoder 420, and the Idx values in stream order from the Stream Buffer 430. For compressed blocks, Output Packer 450 inserts the header pixel field, BFLC field, and any padding needed in the padding field for each compressed block, resulting in an output transaction. Method 800 then continues to block 818 discussed below.

In the event that the determination at block 812 is to output uncompressed blocks, method 800 continues to block 816 where the PCM tiles are processed. The Output Packer 450 will convert the input tile to the PCM tile format for transmission in an output transaction. In an embodiment, when the Output Packer 450 receives such indication that the output will be a PCM tile the Output Packer 450 may perform such conversion on the source pixels received from the Unpacker 410. The Encoder Controller 460 will send a signal to the upstream module to re-send the source pixels prior to performing such conversion.

Method 800 continues from either block 814 or 816 to block 818 where the final output transaction is generated. Note that in some embodiments of method 800 block 818 may not be a separate step, but may be part of step 814 for compressed tiles and/or step 816 for PCM tiles. Generating the final output transaction, may comprise Output Packer 450 packing the compressed (or PCM) data into an output interface format, which may be 128-bit per output transaction. Additionally, the Output Packer 450 may add metadata to each tile, where the metadata is configured to inform downstream components or modules how big the compressed media tile is. Method 800 then returns.

As noted above for FIG. 4, one or more of Unpacker 410, Block Encoder 420, neighbor Manager 440, Output Packer 450, and/or Encoder Controller 460 may be implemented in hardware, software, or both in various embodiments. When implemented in software, one or more of these components or modules may be stored on any computer-readable medium for use by, or in connection with, any computer-related system or method. In the context of this document, a computer-readable medium is an electronic, magnetic, optical, or other physical device or means that can contain or store a computer program and data for use by or in connection with a computer-related system or method.

The various elements may be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random-access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, for instance via optical scanning of the paper or other medium, then compiled, interpreted or otherwise processed in a suitable manner if necessary, and then stored in a computer memory.

In an alternative embodiment, where one or more of Unpacker 410, Block Encoder 420, neighbor Manager 440, Output Packer 450, and/or Encoder Controller 460 are implemented in hardware, the various hardware logic may be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the disclosure. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Although selected aspects of certain embodiments have been illustrated and described in detail, it will be understood that various substitutions and alterations may be made therein without departing from the spirit and scope of the present disclosure, as defined by the following claims.

What is claimed is:

1. A method for out-of-stream-order compression of multi-media data tiles in a system on a chip (“SoC”) of a portable computing device (“PCD”), the method comprising:
receiving an input data transaction comprising an uncompressed data tile;
extracting a header pixel of at least one sub-tile of the received uncompressed data tile, each sub-tile comprising a plurality of data blocks received in an input order;
encoding the plurality of data blocks in the input order, wherein the encoding generates an Idx code and a BFLC code for each of the plurality of data blocks;
storing the Idx code for each of the plurality of encoded data blocks in a stream buffer; and
packing the header pixel, a BFLC code for each of the plurality of encoded data blocks, and the Idx code for each of the plurality of encoded data blocks from the stream buffer into an output format.

2. The method of claim 1, wherein storing the Idx code for each of the plurality of encoded data blocks in the stream buffer further comprises:
storing the Idx code for each of plurality of encoded blocks in an output order.

3. The method of claim 2, wherein the stream buffer comprises a flop array.

4. The method of claim 1, further comprising:
providing neighbor information associated with a pixel of one of the plurality of data blocks encoded.

5. The method of claim 4, wherein encoding the plurality of data blocks is based in part on the neighbor information.

6. The method of claim 1, further comprising:
determining whether to output the uncompressed data tile.

7. The method of claim 6, wherein the determination is made based on a compressed size of the data tile.

8. The method of claim 6, further comprising:
processing the uncompressed data tile into the output format.

9. A system for providing out-of-stream-order compression of multi-media data tiles in a system on a chip (“SoC”) of a portable computing device (“PCD”), the system comprising:
an unpacker, the unpacker configured to:
receive an input data transaction comprising an uncompressed data tile, and
extract a header pixel of at least one sub-tile of the received uncompressed data tile, each sub-tile comprising a plurality of data blocks received in an input order;
a block encoder in communication with the unpacker configured to:
receive the plurality of data blocks from the unpacker in the input order,
encode the plurality of data blocks to generate an Idx code and a BFLC code for each of the plurality of data blocks;
a stream buffer in communication with the block encoder, the stream buffer configured to store the Idx code for each of the plurality of data blocks; and
an output packer in communication with the unpacker, block encoder, and the stream buffer, the output packer configured to:
receive the header pixel the header pixel from the unpacker, the BFLC code for each of the plurality of encoded data blocks from the block encoder, and the Idx code for each of the plurality of encoded data blocks from the stream buffer, and
pack the header pixel, the BFLC code, and the Idx code for each received data block into an output format.

10. The system of claim 9, wherein the stream buffer is configured to provide the Idx code for each of the plurality of encoded blocks to the output packer in an output format.

11. The system of claim 10, wherein stream buffer comprises a flop array.

12. The system of claim 9, further comprising:
a neighbor manager in communication with the unpacker and the block encoder, the neighbor manager is configured to:
receive a neighbor information update from the unpacker, and
provide neighbor information to the block encoder, the neighbor information associated with a pixel of one of the plurality of data blocks being encoded by the block encoder.

13. The system of claim 12, wherein the block encoder is further configured to encode the data block based in part on the neighbor information.

14. The system of claim 9, wherein block encoder is further configured to determine whether to output the uncompressed data tile.

15. The system of claim 14, wherein the determination is made based on a compressed size of the data tile.

16. The system of claim 14, wherein the output packer is further configured to:
receive the uncompressed data tile from the unpacker, and
process the uncompressed data tile into the output format.

17. A system for out-of-stream-order compression of multi-media data tiles in a system on a chip (“SoC”) of a portable computing device (“PCD”), the system comprising:
means for receiving an input data transaction comprising an uncompressed data tile;
means for extracting a header pixel of at least one sub-tile of the received uncompressed data tile, each sub-tile comprising a plurality of data blocks received in an input order;
means for encoding the plurality of data blocks in the input order wherein the means for encoding generates an Idx code and a BFLC code for each of the plurality of data blocks;
means for storing the Idx code for each of the plurality of encoded data blocks from the block encoder; and
means for packing the header pixel from the means for receiving, the BFLC code for each of the plurality of encoded data blocks from the means for encoding, and the Idx code for each of the plurality of encoded data blocks from the means for storing into an output format.

18. The system of claim 17, wherein means for storing the Idx code for each of the plurality of encoded data blocks further comprises:
means for storing the Idx code for each of plurality of encoded blocks in an output order.

19. The system of claim 17, further comprising:
means for providing neighbor information to the means for encoding, the neighbor information associated with a pixel of one of the plurality of data blocks encoded by the means for encoding.

20. The system of claim 19, wherein encoding the plurality of data blocks is based in part on the neighbor information.

21. The system of claim 17, further comprising:
determining whether to output the uncompressed data tile.

22. The system of claim 21, wherein the determination is made based on a compressed size of the data tile.

23. The system of claim 22, wherein the means for packing further comprises:
means for processing the uncompressed data tile into the output format.

24. A computer program product comprising a computer usable medium having a computer readable program code embodied therein, said computer readable program code adapted to be executed to implement a method for out-of-stream-order compression of multi-media data tiles in a system on a chip (“SoC”) of a portable computing device (“PCD”), the method comprising:
receiving an input data transaction comprising an uncompressed data tile;
extracting a header pixel of at least one sub-tile of the received uncompressed data tile, each sub-tile comprising a plurality of data blocks received in an input order;
encoding the plurality of data blocks in the input order wherein the encoding generates an Idx code and a BFLC code for each of the plurality of data blocks;
storing the Idx code for each of the plurality of encoded data blocks in a stream buffer; and
packing the header pixel, the BFLC code, and the Idx code for each of the plurality of encoded data blocks from the stream buffer into an output format.

25. The computer program product of claim 24, wherein storing the Idx code for each of the plurality of encoded data blocks in the stream buffer further comprises:
storing the Idx code for each of plurality of encoded blocks in an output order.

26. The computer program product of claim 24, the method further comprising:
providing neighbor information associated with a pixel of one of the plurality of data blocks encoded.

27. The computer program product of claim 26, wherein encoding the plurality of data blocks is based in part on the neighbor information.

28. The computer program product of claim 24, the method further comprising: determining whether to output the uncompressed data tile.

29. The computer program product of claim 28, wherein the determination is made based on a compressed size of the data tile.

30. The computer program product of claim 28, the method further comprising:
processing the uncompressed data tile into the output format.
